(19) United States
(12) Patent Application Publication
(10) Pub. No.: US 2014/0226259 A1
(43) Pub. Date: Aug. 14, 2014

(54) Mitigating the Effects of Cracks in Metallized Polymer Film Capacitor Arc-Sprayed End Connections

(71) Applicant: SBE, INC., Barre, VT (US)

(72) Inventors: Terry Hosking, Barre, VT (US); Samantha Ryan, Barre, VT (US)

(73) Assignee: SBE, INC., Barre, VT (US)

(21) Appl. No.: 13/765,698

(22) Filed: Feb. 13, 2013

(51) Int. Cl. H01G 4/012

(52) U.S. Cl. CPC H01G 4/012
USPC 361/304

(57) ABSTRACT

With respect to the construction and manufacture of well known prior art metallized polymer film capacitors, a technique is described to mitigate the effects of cracks that may develop in the arc sprayed metal connections to the capacitor electrodes when the capacitor diameter becomes large.

### PRIOR ART

The construction of a metallized polymer film capacitor is well known prior art, but repeated here for background that will facilitate understanding the issues that drove the idea of this invention. Two layers of polymer film are coated with vacuum deposited electrodes such that the metal pattern on each is a mirror image of each other. As shown in FIG. 1, two layers of said polymer film 100A, 100B with attached vacuum deposited metal electrodes are wound into a cylindrical capacitor element 101. FIG. 1B depicts an idealized cross section as a film stack-up drawing with all of the film edges 102 perfectly even. The two films 100A, 100B are wound with an offset such that film edges with the metal electrode 104 extend axially past the film edges with an insulating margin 103. The extension of the film with metallized electrode 104 extending past the film with the insulation margin 103 provides a mechanism by which these electrodes can be connected to the outside world to form a useful capacitor. The method of connection is shown in FIG. 2. The axial faces 200A of the completed metallized film capacitor winding 200 are arc sprayed with molten metal droplets 201 to form an electrical and mechanical layer 202 at each end of the capacitor which allows connection of the capacitor winding to terminals or lead wires.

It is useful at this point to look in more detail at the way the film layers stack up during the winding, and possible deviations from ideal. FIG. 1B shows the ideal uniform film position 102. FIG. 3 shows realistic variance in film position. Film position discontinuities 300 occur for any number of reasons, including but not limited to splicing or supply roll wobble. This creates an undesired circumferential discontinuity on the axial surface of the capacitor as the winding diameter increases past the discontinuity. Regardless of the cause, film position discontinuities can initiate and precipitate circumferential cracks in the arc sprayed metal surface.

### BACKGROUND FOR THE IDEA OF THE INVENTION

The maximum size of polymer film capacitor windings is limited by the capability of past and present commercially available capacitor winding machines. Recent development has led to proprietary capacitor winding machines that allow fabrication of single polymer film capacitor windings up to 15″ in diameter and beyond. These windings are so large that a single pair of metallized film supply rolls is not sufficient to complete a capacitor winding. Film from additional supply rolls must be spliced to the winding such that it can be completed to the desired diameter. To create the most cost effective capacitors, it is necessary to maximize raw film usage. Given the supply roll size, the number of splices in a given capacitor winding can be predicted, but their radial location cannot. In addition to splices defined by film supply roll size, it may be required to repair an unsatisfactory “factory splice” within any given film supply roll. The unavoidable process of making a splice in a winding has a high probability of generating a film position discontinuity 300 as illustrated in FIG. 3. Even if an operator is capable of performing a “perfect splice”, there is a high probability of supply roll film width variation which will result in a step change in the axial dimension of the capacitor winding.

Manufacture of such large wound film capacitors has highlighted issues that are seldom of consequence for smaller prior art windings. One of the issues involves cracking of the arc-sprayed metal applied to the axial faces of a wound metallized film capacitor to make contact with the capacitor electrodes. The previously described prior art arc-spray process forms a porous conductive matrix rather than a layer of solid metal. This matrix is very weak under tensile stress. The tensile stress occurs during thermal processing of the capacitor winding that follows application of the arc-sprayed metal, and also during temperature changes in the capacitor application. This tensile stress arises in the arc-sprayed metal because the Thermal Coefficient of Expansion (TCE) of the winding is significantly higher than the TCE of the arc-sprayed metal, and increasingly so as the temperature is increased. [TCE of the winding is a strong function of temperature.] These cracks may take on several forms, but all are the result of this TCE mismatch. The materials properties that explain these cracks are not new phenomena and the same mechanism creates forces that tend to form cracks in all metallized film capacitors. These forces accumulate over radial distance, so the larger diameter windings are more likely to exhibit cracks. For the purposes of this patent application “radial” refers to “along a line from the center of the winding to the outside diameter”.

FIG. 4 illustrates a partial cross-section view of a large film capacitor 400 wound on a hollow core 406. Said capacitor has had the previously described arc-sprayed metal 401 applied to both axial faces. A previously described example of film position discontinuity 402 such as but not limited to the location of a splice is shown. This film position discontinuity results in locally thin coverage 403 of the applied arc sprayed metal.

FIG. 4B illustrates the result if the temperature is raised. As previously described, the film expands radially more than does the arc sprayed metal resulting in sufficient tension in the arc sprayed metal to break it and form a circumferential crack 404 at the radial location of the film position discontinuity. Further increases in temperature would likely result in an additional crack in the arc sprayed metal 405 where it is also thin as a result of the illustrated film position discontinuity. It should be noted that after the capacitor cools, the crack(s) will close so precisely that they often become nearly invisible. It should also be noted that these cracks do not necessarily form during the first temperature increase. They often develop after temperature cycling, as the arc-sprayed metal is subject to fatigue failure at relatively low stress levels.

FIG. 5 illustrates a large capacitor winding 500, with a pair of terminals 501 and with a previously described circumferential crack 502. This circumferential crack divides the total capacitance by the ratio of the surface area inside 503 and outside 504 of the crack. The capacitance contained by the portion of the winding outside the crack 504 is well connected to the terminals 501. The capacitance contained Inside the crack 503 has poor if any electrical connectivity to arc sprayed metal outside the crack and thus to the terminals. Because the root cause of the cracking is the TCE mismatch between capacitor materials, it is highly unlikely that said root cause can be designed out. If one wishes to adopt the advantages of a single monolithic capacitor winding, one must design the resulting capacitor in a way that it will meet application requirements in spite of the tendency to crack as described.

U.S. Pat. No. 7,453,114; November 2008 and U.S. Pat. No. 7,655,530; February 2010 teach a method for connecting a capacitor to a terminal structure in such way where cracks are forced to occur at defined locations where they will not influence capacitor performance. Refer to U.S. Pat. No. 7,453,114, FIG. 1 which illustrates a method to mitigate the effects of such cracking by providing stress relief. The area covered by arc sprayed metal is divided into segments [by intentional scribing or by other means] which are small enough so that over the useful operating temperature range of the capacitor, the radial tension force developed within each segment is not sufficient to cause circumferential cracks there in. Again referring to U.S. Pat. No. 7,453,114 FIG. 1, a separate electrical connection from each segment must be made to the capacitor terminals. The connection must be flexible to allow the segments to move radially. This construction method has enabled very high performance capacitors which have been successfully commercialized. The complex terminal to arc sprayed metal interconnect is justified for those applications requiring very high continuous current carrying capability. As capacitor size increases, the number of segments required to mitigate arc sprayed metal cracking increases as does the area of the arc sprayed metal surface, and the interconnect required between the segmented arc sprayed surface and terminals becomes increasingly complex and costly, although remaining justifiable for very high current applications.

Many large capacitor windings are used for energy storage, with infrequent but very high pulse current discharges. Referencing FIG. 5, If the capacitor is rapidly discharged, there will be arcing along the crack 502 as the charge stored in the capacitance inside the crack jumps the crack after sufficient voltage develops between the inside 503 and the outside 504 capacitances. This behavior results in poor capacitor performance, and eventual failure because of the heat developed at the arc sites. While the techniques taught by U.S. Pat. Nos. 7,453,114 and 7,655,530 will mitigate this problem [randomly located circumferential cracking], the parallel [FIG. 1, U.S. Pat. No. 7,453,114] interconnect of each segment would be very much more complex than the end use application may warrant. The economic incentive to make a single winding capacitor is to simplify the manufacturing process to obtain a competitive edge in the marketplace.

### IDEA OF THE PRESENT INVENTION

Problem:

Part of the capacitance of a large metallized polymer film capacitor winding is electrically isolated by the presence of circumferential crack(s) at random radial locations in the arc sprayed metal applied to the axial faces of said capacitor for the purpose of contacting the vacuum deposited metal electrodes on the capacitor film. Although utility and methods have been taught to mitigate the problem by U.S. Pat. Nos. 7,453,114 and 7,655,530, another solution is needed that is less costly and complex to implement.

Solution:

The idea of the present invention is to utilize [independent of capacitor terminals] auxiliary conductors electrically and mechanically attached to the arc sprayed metal on the axial surfaces of large monolithic capacitor windings to electrically tie the arc sprayed metal together such that circumferential cracks no longer interrupt current flow. The auxiliary conductor [or plurality of same] enables less complex, lower cost terminal designs. These auxiliary conductor(s) mitigate the problem completely and in preferred embodiments are tolerant of capacitor winding dimension changes with temperature. These preferred embodiments also meet a requirement that if melted metal (e.g. soldered or welded) mechanical and electrical attachments are made between the auxiliary conductors and the arc sprayed metal, the conductor orientation at the location of such attachments must be essentially radial to prevent additional arc sprayed metal cracking adjacent to the attachments as they are made.

It should be noted that extending capacitor terminals to cover all arc sprayed metal radii will not solve the problem. Terminals are typically rigid with a TCE similar to the arc sprayed metal, and the means of attachment are typically rigid as well. This would further restrict the arc sprayed metal's ability to expand with the film winding during thermal processing; in fact the arc sprayed metal will crack around locations where such terminals are attached to the arc sprayed metal, exacerbating the problem rather than alleviating it.

An additional idea of the invention is to apply the same concept of auxiliary conductors to an embodiment where they directly attach to capacitor terminals as opposed to being independent from the capacitor terminals.

### DETAILED DESCRIPTION OF THE INVENTION

FIG. 5 illustrates a capacitor winding 500 large enough [with a diameter at or over 150 mm] for the development of arc sprayed metal cracks. One crack 502 is shown, effectively dividing the capacitor into two parts, inner 503 and outer 504. One can envision a simple conductor 505 attached 506 to the arc sprayed metal to electrically bridge the crack 502. This of course ties the inner and outer capacitances together as desired, but as temperature increases, the crack 502 will widen 508. This will put extreme tension on the conductor 505 and its attachment locations 506. This problem can be removed by attaching a bent conductor 507 such that as the crack 502 opens and closes with temperature the bent conductor 507a will flex and impart no significant stress on said conductor and its attachment locations 506.

Referencing FIG. 6, a conductor 600 [or a plurality of same] with a plurality of bends is electrically and mechanically attached at locations 601 such that cracks at any radius are bridged should they occur. Although the attachments could be by any conductive means such as, but not limited to, silver filled epoxy, it is economically advantageous to use melted metal based [welding, soldering, resistance soldering] attachment methods. For all attachment methods, it is important to locate the attachment locations 601 on the conductor 600 at or near the midpoint between bends to minimize the force on said attachment points should a crack develop between the attachment points. It is not required that attachment points be between every bend in the conductor 600 but a plurality of attachment points is recommended such that the conductor length across any crack is minimized. For the case where electrical heating is used to create a melted metal attachment, it is important to consider that the electrodes that carry the heating current must force the conductor 600 axially against the arc spray metal surface to enable current to flow in the conductor, heating it to the melting point of the arc spray metal. After the arc spray metal melts, this contact force will cause the conductor to sink into the arc sprayed metal surface, often until it lays on the film layers underneath. As shown by FIG. 6B, it is desirable that resistance heated melted metal attachments to be made at locations 601 where the conductor orientation is essentially or mostly along a radial line through the center of the capacitor winding to the winding OD.

Note that although the drawing is far from being to scale, that a great number of film layers support the conductor and limit the distance that the conductor can sink into the arc sprayed metal layer.

FIG. 6C shows an enlarged illustrative view of a hypothetical melted metal attachment at a location 602 where the conductor 600 is oriented along a line predominantly circumferential to the radius at said attachment point. Again, the drawing is far from being to scale, but it can be seen that the conductor is supported by only a relatively few film layers. The force of the electrical contacts at the top of the conductor 600 at the weld location 602 shown will push the conductor much further into the film. This occurs so rapidly that the arc sprayed metal will crack 603 at locations adjacent and parallel to the conductor at the attachment point. This phenomenon will deteriorate the ability of the conductor to provide a good current path across a potential crack. There is also the possibility that the conductor will sink far enough into the capacitor windings to bridge both of the capacitor electrodes, creating a short circuit which may or may not be removable by subsequent manufacturing processes, the details of which are not relevant to the idea of the invention.

FIG. 7 illustrates the concept of how an auxiliary conductor [or plurality of same] 700 with a plurality of bends can be attached 701 to the capacitor terminals 501 to accomplish the same electrical function. Again, a conventional terminal lengthened to tie together all radii of the arc sprayed metal layer would be completely unsatisfactory, as it has been found that the expansion of the capacitor winding will break the arc sprayed metal around the periphery of the locations where said terminal is attached to said arc sprayed metal.

It should be noted that there are many different conductor forms that could accomplish the crack bridging intent of said conductors. The preferred embodiment illustrated is a manufacturable example of the many that will become immediately obvious to anyone skilled in the art of capacitor design and manufacture. The claims include the conductors in any form that accomplishes the crack bridging function of same.

### BRIEF DESCRIPTION OF THE SEVERAL VIEWS OF THE DRAWING

FIG. 1 is an illustration of the basic construction of metallized film capacitor

FIG. 1B is a partial cross section view of FIG. 1

FIG. 2 shows how arc sprayed metal is applied to connect capacitor electrodes.

FIG. 3 is a cross sectional picture showing film position discontinuity

FIG. 4 shows how film position discontinuity can cause thin spots in the arc sprayed metal

FIG. 4B shows how the thin spots become the cracks that develop under thermal stress.

FIG. 5 shows a capacitor with a circumferential crack dividing the capacitance and interrupting radial current flow. It also introduces the concept of using a conductor to bridge the crack and provide the missing current path, and how a bent conductor provides the needed stress relief on this conductor.

FIG. 6 shows a preferred embodiment of the idea of the invention using conductor(s) with a plurality of bends employed to generally mitigate cracks at arbitrary locations.

FIG. 6B illustrates, in a small cross-sectional cutaway, the preferred—radial—weld location & orientation

FIG. 6C illustrates, in a small cross-sectional cutaway, the cracks that can develop if the weld location and orientation is more in the circumferential direction.

FIG. 7 shows another preferred embodiment using conductors with a plurality of bends directly attached to terminals.

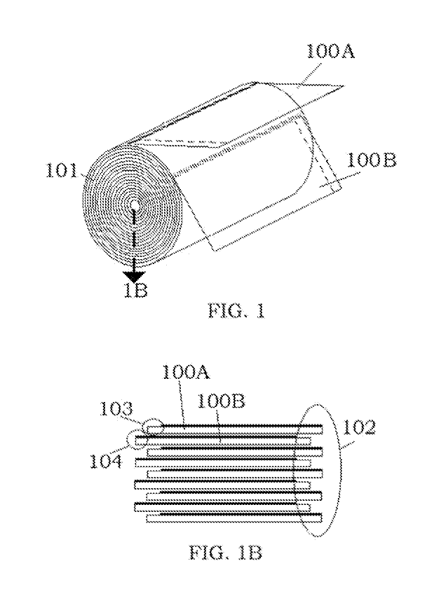

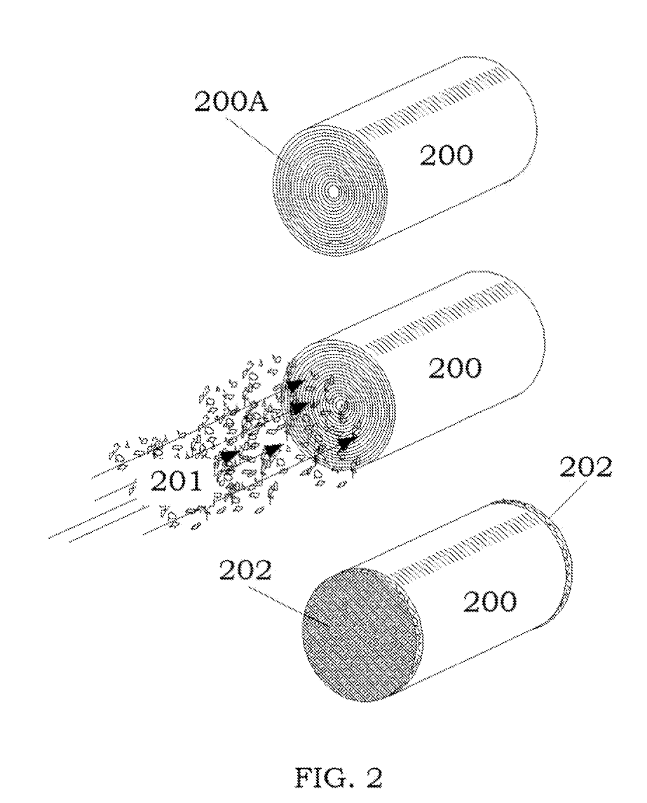

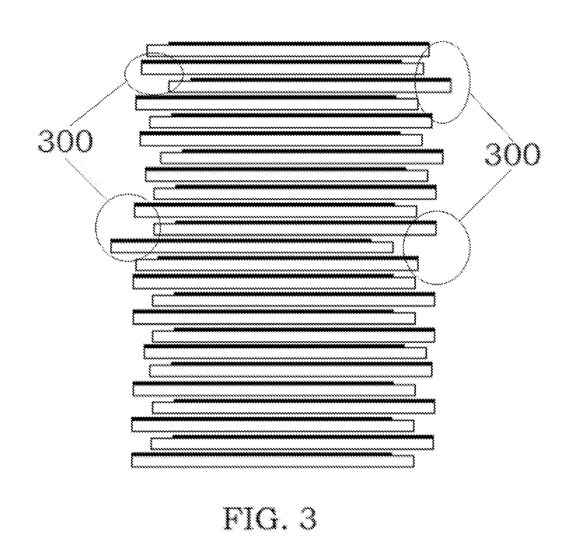

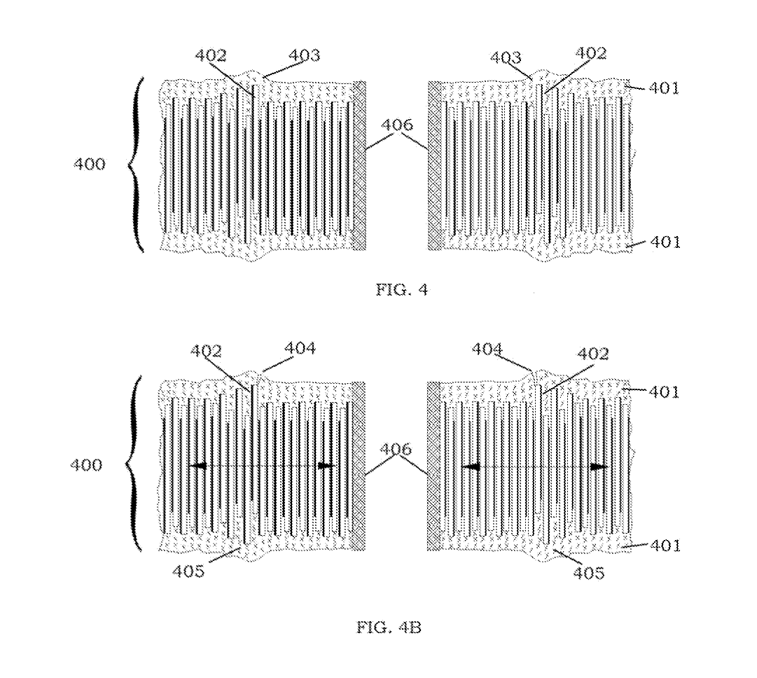

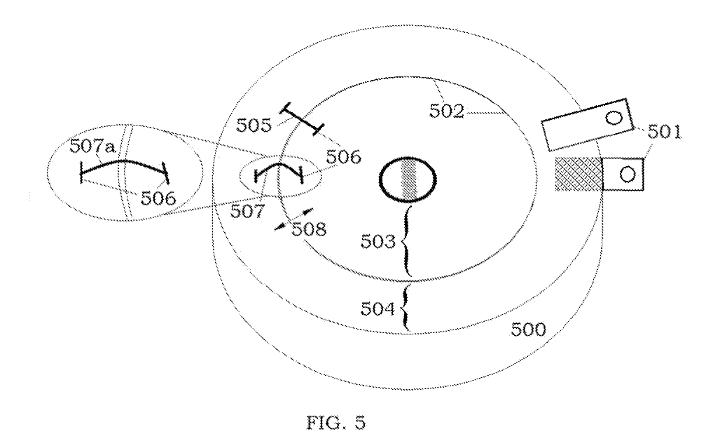

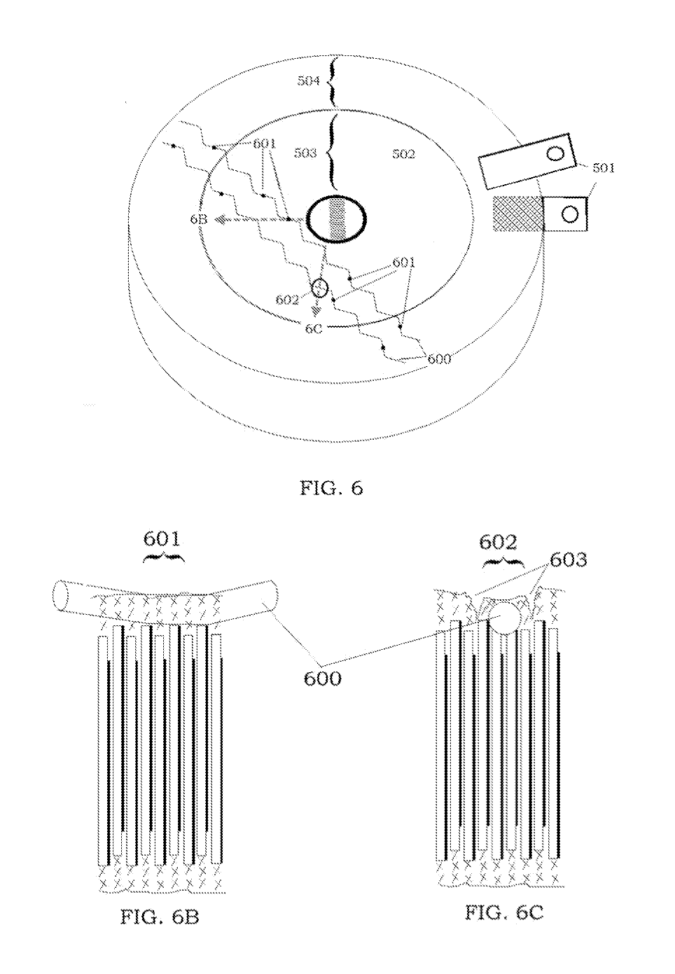

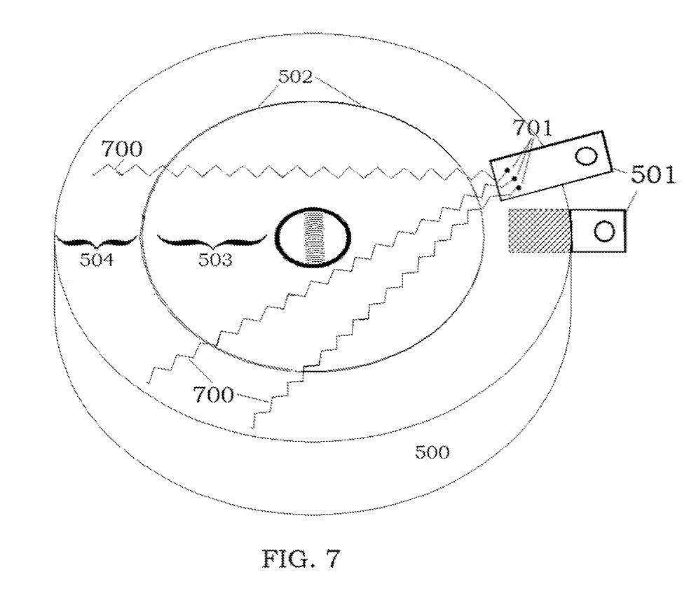

For a prior art wound polymer film capacitor with arc sprayed metal electrical connections to the film electrodes at each end of the winding and terminals electrically attached to the arc sprayed metal I claim:

1. One or more conductors can be advantageously electrically attached to said arc sprayed metal to mitigate the loss of the current path in said arc sprayed metal should one or more circumferential cracks develop in the arc sprayed metal on either axial surface of the winding.

2. One or more conductors can be advantageously arranged as in claim 1 in a manner such that as the width of cracks in the arc sprayed metal vary with temperature the mechanical stress is minimized at the locations where said conductors are attached to the arc sprayed metal.

3. One or more conductors advantageously arranged as in claim 1 such that additional cracking of the arc sprayed metal by the attachment process is minimized by attaching the conductor to the arc sprayed metal only where the conductor is oriented in a direction predominantly along a line from center of the winding to the outside of the winding.

4. One or more conductors can be advantageously electrically attached to said arc sprayed metal to mitigate the loss of the current path in said arc sprayed metal should one or more circumferential cracks develop in the arc sprayed metal on either axial surface of the winding.

5. One or more conductors can be advantageously arranged as in claim 4 in a manner such that as the width of cracks in the arc sprayed metal vary with temperature the mechanical stress is minimized at the locations where said conductors are attached to the arc sprayed metal.

6. One or more conductors advantageously arranged as in claim 4 such that additional cracking of the arc sprayed metal by the attachment process is minimized by attaching the conductor to the arc sprayed metal only where the conductor is oriented in a direction predominantly along a line from center of the winding to the outside of the winding.
